(19) United States
(12) Patent Application Publication
(10) Pub. No.: US 2002/0191000 A1
(43) Pub. Date: Dec. 19, 2002

(54) Interactive stereoscopic display of captured images

(75) Inventor: Jeffrey S. Henn, Phoenix, AZ (US)

Correspondence Address: Christine Q. McCleod, esq., BEUSSE, BROWNLEE, BOWDOIN & WOLTER, P.A., 390 N. ORANGE AVENUE, SUITE 2500, ORLANDO, FL, 32801, US

(73) Assignee: St. Joseph's Hospital and Medical Center, Phoenix, AZ

(21) Appl. No.: 09/882,865

(22) Filed: Jun. 14, 2001

(51) Int. Cl. G09G 5/00

(52) U.S. Cl. 345/619

(57) ABSTRACT

A system and method for creating and viewing stereoscopic sequences of an environment. A virtual reality experience is provided to a user that can be used for various applications. These applications include, but are not limited to, surgery. In a method according to one embodiment of the present invention, interactive stereoscopic sequences of an environment are created, by: (a) positioning an image capturing device with respect to the environment; (b) capturing at least two two-dimensional images of at least a portion of the environment using the image capturing device; and (c) repeating steps (a) and (b) for a plurality of positions of interest; wherein the images are a spatially ordered part of the same environment and can be viewed as part of an interactive experience.

### FIELD OF THE INVENTION

This invention relates generally to the field of virtual reality, and more particularly to a system and method for the interactive stereoscopic display of captured images.

### BACKGROUND OF THE INVENTION

The process of learning anatomy is difficult. This is due both to the inherent complexity of the subject and to limitations of standard educational methods. However, the ultimate success of a surgical approach is often contingent upon a mastery of this complex three-dimensional anatomy. Although the intricacy of the anatomy is a given, computer-based educational techniques can significantly improve understanding and speed the process of learning while at the same time not posing risks to a patient.

The time-proven standards for surgical education include a combination of textbooks, cadaver dissection and intraoperative training. There are some intrinsic disadvantages to each of these methods. For example, textbook-based anatomy is two-dimensional (2D), limited to fixed views and difficult to extrapolate to views encountered during a surgical approach. Even surgical atlases, based on images obtained from a surgical perspective, fall short of representing intricate details normally only available with three-dimensional (3D) images or in-person viewing. Another limitation of textbooks is that when multiple images are used to represent anatomic relationships, the spatial correlation between these images is not obvious. Consequently, while textbooks provide an important foundation for surgical education, there remains a significant need to augment learning through other techniques.

Cadaveric dissection is an invaluable tool for learning surgical anatomy and techniques. The process is interactive, 3D and readily applied to the operating room setting. Unfortunately, several practical limitations exist. These limitations include limited availability of cadavers, costs (preparation, facilities, instructors, instruments, etc.), and instructor availability. As a result, cadaveric dissection typically accounts for only a small fraction of a surgical resident's education.

Ultimately, surgical anatomy and techniques are typically learned in the operating room through an apprentice-type relationship with a senior surgeon. The anatomy and skills learned in this setting typically form the foundation for a surgeon's career. While this type of learning is the paragon for surgical education, it too has some relative disadvantages. Learning in the operating room tends to be relatively high-pressured and time limited. In addition, anatomy of a living patient can only be exposed to a degree and for a length of time that is clinically warranted. It would therefore be desirable to improve educational systems and methodologies for studying anatomy and surgical technique outside of the operating room setting.

### SUMMARY OF THE INVENTION

According to embodiments of the present invention, a system and method are provided for creating and viewing stereoscopic sequences of an environment. A virtual reality experience is provided to a user that can be used for various applications. These applications include, but are not limited to, surgery.

In a method according to one embodiment of the present invention, interactive stereoscopic sequences of an environment are created, by: (a) positioning an image capturing device with respect to the environment; (b) capturing at least two two-dimensional images of at least a portion of the environment using the image capturing device; and (c) repeating steps (a) and (b) for a plurality of positions of interest; wherein the images are a spatially ordered part of the same environment and can be viewed as part of an interactive experience.

In a specific embodiment, interactive stereoscopic sequences of an environment are created using a digital camera unit and (a) positioning the digital camera with respect to the environment; (b) capturing at least two two-dimensional images of at least a portion of the environment; and (c) repeating steps (a) and (b) for a plurality of positions of interest; wherein the environment is part of an anatomy and the digital camera unit is coupled to a microscope, the digital camera unit including a first digital camera coupled to a first lens of the microscope and a second digital camera coupled to a second lens of the microscope; and wherein the two-dimensional images of the at least a portion of the environment are captured such that the images are limited in view; wherein each image represents a limited portion of the environment and at least two images can contain common image data such that the at least two images overlap, and the two-dimensional images of the at least a portion of the environment are captured such that the overall field of view of the environment is limited.

A system according to another embodiment of the present invention for creating interactive stereoscopic sequences of an environment includes a digital camera unit positionable with respect to the environment and configured to capture at least two two-dimensional images of at least a portion of the environment at a plurality of digital camera positions of interest; wherein the two-dimensional images of the at least a portion of the environment are captured such that the images are limited in view, wherein each image represents a limited portion of the environment and at least two images can contain common image data such that the at least two images overlap, and the two-dimensional images of the at least a portion of the environment are captured such that the overall field of view of the environment is limited; wherein the environment is part of an anatomy and the digital camera unit is coupled to a microscope, the digital camera unit including a first digital camera coupled to a first lens of the microscope and a second digital camera coupled to a second lens of the microscope.

In a method according to another embodiment of the present invention, a user can virtually navigate through an environment. The method comprises: (a) viewing a first stereoscopic image that is comprised of at least two two-dimensional images of at least a portion of the environment; (b) providing input to a system to select a different stereoscopic image other than the first stereoscopic image; and (c) repeating steps (a) and (b) such that a plurality of stereoscopic images are viewed, wherein the images are a spatially ordered part of the same environment and can be viewed as part of an interactive experience.

In a method according to another embodiment of the present invention, a user can virtually navigate through an environment. The method comprises: (a) viewing a first stereoscopic image that is comprised of at least two two-dimensional images of at least a portion of the environment; (b) providing input to a system to select a different stereoscopic image other than the first stereoscopic image; and (c) repeating steps (a) and (b) such that a plurality of stereoscopic images are viewed; wherein the environment is part of an anatomy and the stereoscopic images are taken with the aid of a microscope; and the two-dimensional images of the at least a portion of the environment are captured such that the images are limited in view; wherein each image represents a limited portion of the environment and at least two images can contain common image data such that the at least two images overlap, and the two-dimensional images of the at least a portion of the environment are captured such that the overall field of view of the environment is limited.

A system for virtually navigating in an environment according to another embodiment of the present invention, comprises: a viewer configured to display a first stereoscopic image that is comprised of at least two two-dimensional images of at least a portion of the environment; an input device, wherein the input device can accept an input that will cause a stereoscopic image other than the first stereoscopic image to be selected; the environment is part of an anatomy and the stereoscopic images are taken with the aid of a microscope; and the two-dimensional images of the at least a portion of the environment are captured such that the images are limited in view; wherein each image represents a limited portion of the environment and at least two images can contain common image data such that the at least two images overlap, and the two-dimensional images of the at least a portion of the environment are captured such that the overall field of view of the environment is limited.

A system for virtually navigating in an environment according to another embodiment of the present invention, comprises: viewing means for displaying a first stereoscopic image that is comprised of at least two two-dimensional images of at least a portion of the environment; input means for accepting input, wherein the input means can accept an input that will cause a stereoscopic image other than the first stereoscopic image to be selected; wherein the environment is part of an anatomy and the stereoscopic images are taken with the aid of a microscope; and wherein the two-dimensional images of the at least a portion of the environment are captured such that the images are limited in view; wherein each image represents a limited portion of the environment and at least two images can contain common image data such that the at least two images overlap, and wherein the two-dimensional images of the at least a portion of the environment are captured such that the overall field of view of the environment is limited.

A further understanding of the nature and advantages of the inventions herein may be realized by reference to the remaining portions of the specification and the attached drawings.

### BRIEF DESCRIPTION OF THE DRAWINGS

FIG. 1 is a top view of a person viewing an object.

FIG. 2A shows a left eye's view of the object of FIG. 1.

FIG. 2B depicts a right eye's view of the object of FIG. 1.

FIG. 3 depicts a person viewing the object of FIG. 1 from various trajectories/positions.

FIG. 4 is flow diagram of one process according one embodiment of the present invention.

### DESCRIPTION OF THE SPECIFIC EMBODIMENTS

As shown in the exemplary drawings wherein like reference numerals indicate like or corresponding elements among the figures, an embodiment of a system according to the present invention will now be described in detail. In accordance with embodiments of the present invention, the following description sets forth an example of a system and methodology for a stereoscopic display of anatomical captured images. The system can be operated on many different computing platforms, and other variations should be apparent after review of this description.

As mentioned above, it would be desirable to improve educational methods for studying anatomy and surgical technique outside of the operating room setting. In one embodiment according to the present invention, interactive stereoscopic virtual reality (ISVR) is used.

A method and system will be described as relates to neurosurgical education for illustrative purposes; however, it should be noted that any other suitable applications (related to various types of surgery or otherwise) can be used in conjunction with embodiments of the present invention.

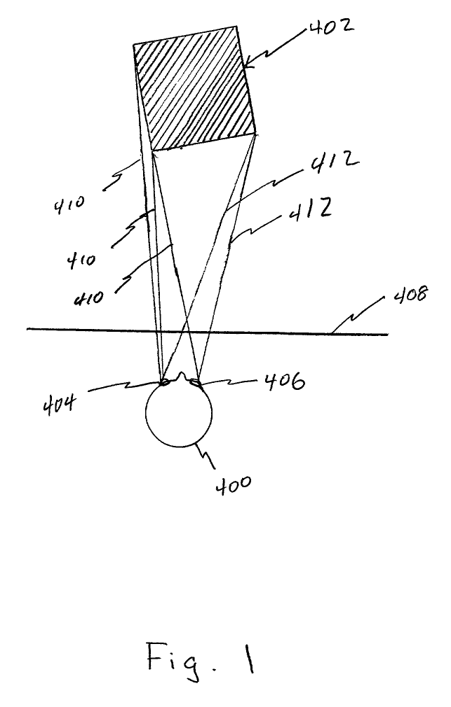

Referring to FIG. 1, a person 400 views an object 402 (in this case a cube) using his or her left eye 404 and right eye 406 to effect binocular vision. In this particular example, the person is standing parallel to a view plane 408. In this example, the view plane happens to be parallel to two sides of the cube. The extent of the cube in the field of view of the left eye is depicted by projection lines 410. Likewise, the extent of the cube in the field of view of the right eye is depicted by projection lines 412.

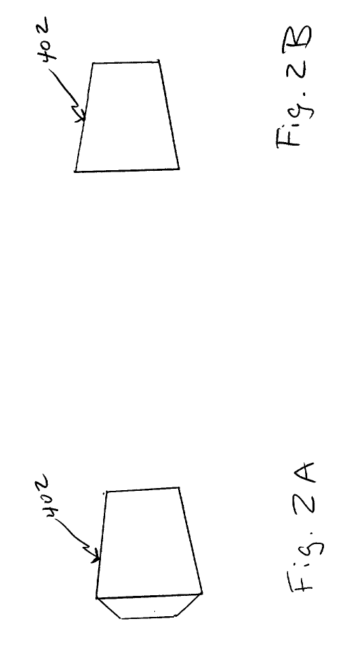

Referring to FIGS. 2A and 2B, it can be seen that two separate images are simultaneously transmitted to the person's 400 brain. A separation of a few inches between the left eye 404 and the right eye 406 results in each eye seeing a different image, causing a binocular disparity. The two images are commonly referred to as a stereo pair.

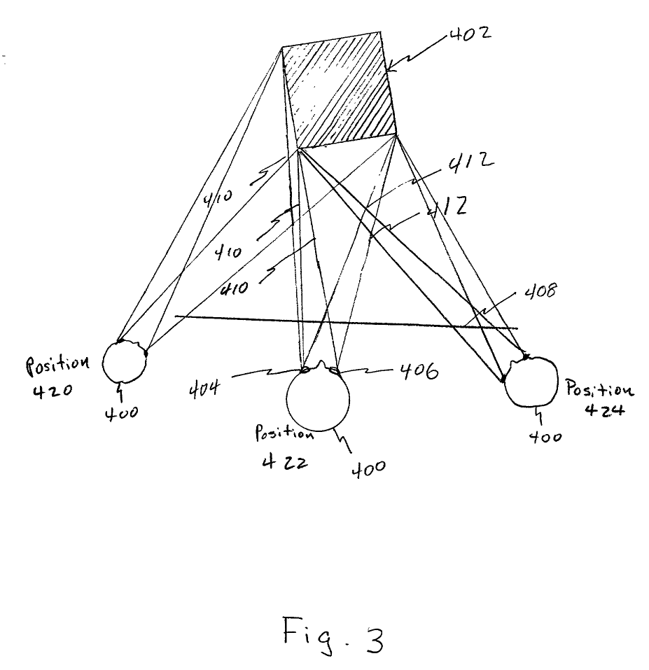

Referring to FIG. 3, the person 400 can view the object 402 (in this case a cube) from various trajectories/positions 420, 422, 424. From each of these trajectories, the person views the cube using his or her left eye 404 and right eye 406 to effect binocular vision. Therefore the person has not only a stereoscopic view of the object, but also may see the object from a plurality of trajectories. This increases the understanding the person has of the details of the object.

ISVR allows accurate recreation of surgical approaches through the integration of several forms of stereoscopic multimedia (video, interactive anatomy and computer-related animations, etc.). In one embodiment, content for ISVR can be obtained through approach-based cadaveric dissections (i.e., cadaveric dissections which emulate a surgical approach), surgical images/video, computer-rendered animations, or any other suitable method. This content can be combined through an interactive software interface to demonstrate every aspect of a given neurosurgical approach.

In one embodiment, stereoscopic video is an element of the ISVR platform and is captured using commercially available 3D microscope cameras. The video is edited and processed for stereoscopic computer display. The interactive stereoscopic anatomy sequences can be created using images obtained from various trajectories. The combination of these images into an interactive platform creates a virtual reality experience for a user.

The process of “panning” (right/left) or “tilting” (up/down) (in order for a user to view various parts of an anatomy) involves sequential display of the appropriate images. Software to create these virtual reality sequences is commercially available. One of the most common platform, QuickTime Virtual Reality (QTVR)™, was developed by Apple Computer™ of Cupertino, California. Unlike demanding three-dimensional computer rendering, QTVR requires only standard digital images. Three-dimensional information can be provided by passive visual cues (e.g., lighting, shadow, angle of sweep, etc.) and the perception of depth can be provided by multiple views of the object(s) or environment. However, the addition of stereoscopic images into the QTVR platform results in an even more powerful effect. The user perceives a three-dimensional anatomy and can interactively manipulate the view.

Computer-rendered stereoscopic animations can also comprise a part of the ISVR platform. These animation sequences are ideal for demonstrating particular aspects of a neurosurgical approach that cannot be demonstrated with traditional imaging techniques. Animations provide the capability to display anatomic relationships and techniques in ways not possible through cadaveric dissection or surgery.

In one embodiment, stereoscopic images of an object(s) or environment (such as part of an anatomy) are captured from definable incremental trajectories for the purpose of creating a stereoscopic interactive virtual reality experience. The images can be captured by positioning a digital camera unit (or any other suitable image capturing device) in a certain position with respect to the environment. The digital camera unit can be coupled to a microscope. The digital camera unit can include a first digital camera coupled to a first lens of the microscope and a second digital camera coupled to a second lens of the microscope. Alternatively, a single camera recording images from two distinct optical paths might be used. Two two-dimensional (2D) images of at least a portion of the environment are captured and stored. Then the digital camera unit is repositioned and another set of two 2D images is captured. This process is repeated for a plurality of positions of the digital camera unit. It is contemplated that in an alternate embodiment more than two images could be captured at each position.

In one embodiment, the digital camera unit and microscope comprise a robotic microscope or robotic stereoscopic microscope. A robotic surgical microscope is a surgical microscope that can be positioned precisely based on a robotic mounting system. Some of the advantages that surgical microscopes provide are magnification, coaxial illumination and binocular visualization through a small opening. The binocular visualization is based on an inter-lens distance. The robotic mount provides the ability to precisely position the operating microscope and to incrementally move the scope through a series of positions/trajectories. Thus, the environment can be viewed from a variety of positions and angles.

In a specific embodiment, a Surgiscope™ system can be used as the microscope system. This system combines a Leica™ operating microscope with a robotic control system created by Jojumarie. This microscope provides the capabilities mentioned above, as well as the advantages of allowing a user to control the microscope position and move the operating microscope in a spherical coordinate system using a precise joystick system. Various other microscopes can be used in conjunction with the present invention, such as a robotic microscope made by Carl Zeiss, Inc., which is known as the MKM™ system.

In one embodiment, the image capturing device can comprise two identical devices with one being used to capture a left-eye image and one being used to capture a right-eye image. Digital cameras or digital video camcorders are some illustrative devices that can be used as part of the image capturing device. Capturing the images in digital form allows for further processing of the images. Some illustrative cameras that can be utilized include the Pixera Professional digital camera, the Nikon D1 digital camera and the Sony CCD video camera. Instead of two separate devices, image capture can be done with one device with two distinct optical paths.

In one embodiment according to the present invention, a desktop computer capable of handling multimedia and image processing can be used. A viewer such as an external monitor in conjunction with stereoscopic glasses can also be used for stereoscopic visualization. There are a number of available systems of stereoscopic glasses including active shuttering glasses, head-mounted LCD displays and passive polarized glasses. Various other viewing systems can be used as well.

In one specific embodiment, the glasses can be Visualizer™ glasses made by Vrex, Inc. These glasses are based on stereoscopic images in a horizontal-interlaced pattern. The glasses work with a standard desktop computer and external CRT monitor. The glasses create stereoscopic visualization by alternating the blanking of odd and even horizontal lines while synchronously darkening the LCD on each side of the glasses. This is performed at the refresh rate of the computer system and monitor. In this way, the left eye sees only the left-eye image (displayed on the even lines of the monitor) and the right eye sees only the right-eye image (displayed on the odd lines of the monitor).

Furthermore, the system can also include image capturing software to provide an interface between the computer and digital camera. This software allows digital images to be obtained and transferred to the computer for further processing. Additionally, image processing software can be used to manipulate the digital images as needed. This manipulation can include resizing, cropping, adjusting the brightness/contrast/color levels, etc.

Further, stereoscopic multiplexing software can be included as part of the system. This software can be used for combining two images into a single stereoscopic image. One exemplary type of stereoscopic multiplexing software is the 3D Studio Factory Plus™ software, which allows two images to be combined into a stereoscopic image and supports several formats including the horizontal-interlaced format. This software also includes a batch-processing function that allows the rapid processing of a large series of images. Moreover, the software also includes the capability to adjust for offset between the two images for slightly misaligned cameras.

Software can be included as a part of the system for combining multiple trajectory images into an interactive interface. This type of software can allow multiple images to be combined into a row/column matrix so that interactively moving through the images in a particular row or column leads to the perceived effect of tilting or panning the object. One type of software that can be used is Apple's QuickTime Virtual Reality (QTVR)™ platform, and software known as VR Worx™.

Additionally, multimedia authoring software can also be included as part of the system. This software allows the stereoscopic interactive sequences to be combined with other forms of stereoscopic multimedia (e.g., video, computer-rendered animation, etc.). One type of multimedia authoring software that can be used to combine these stereoscopic media is Macromedia Director 8™ authoring software. This software also allows the creation of an interactive menu-driven interface that corresponds to sequential steps of a surgical procedure. All steps of a surgical approach can be accurately recreated by mixing the stereoscopic interactive sequences with other forms of stereoscopic multimedia.

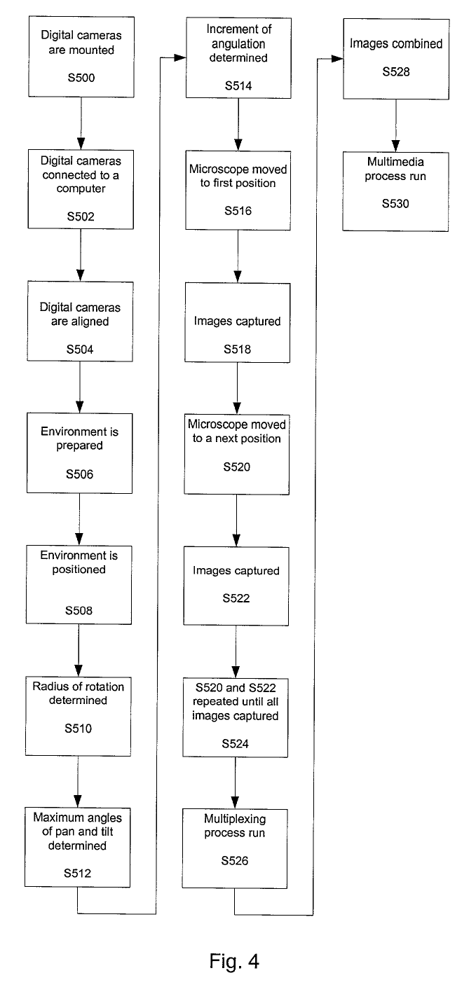

Turning now to FIG. 4, some exemplary steps are shown that can be used to create interactive stereoscopic sequences. While these steps will be specifically described with reference to capturing interactive stereoscopic anatomy sequences, it should be understood that the technique is fundamentally the same for any small or microscopic object.

At step S500, digital cameras are mounted. Using standard microscope adapters, the digital cameras are connected to a microscope. Each of the cameras is connected to one side of the microscope so that one can capture images from the left eyepiece and one can capture images from the right eyepiece.

At step S502, the cameras are connected to a computer and the image capture software is installed.

At step S504, the cameras are aligned with respect to position and rotation. This can be done manually or through an automated process.

At step S506, the object(s)/environment is prepared. Cadaver dissections are performed to carefully expose the relevant anatomy for a specific neurosurgical approach.

At step S508, the object(s)/environment is positioned. A specially designed surgical head-holder known as the Mayfield head-holder can be used. This device is used to hold the cadaver head in the precise position for the surgical approach and, more importantly, to prevent any movement during image acquisition.

At step S510, the appropriate radius of spherical rotation for the operating microscope is determined. This determination is made relative to the focal length of the structures being visualized. If the radius of rotation and focal length are similar, the result will be little apparent movement associated with angle change. Conversely, if there is significant difference between the radius of spherical rotation and focal length, the interactive sequences will exhibit a sweeping quality.

At step S512, the maximum angles of pan (right/left angulation) and tilt (forward/backward angulation) to capture the relevant anatomic structures are determined. The microscope is moved side-to-side and forward-backward to accomplish this. This process allows for limiting the overall field of view a user sees without limiting usability by taking into account narrow views afforded in actual surgery. These views can be limited not only with respect to the overall field of view, but also with respect to each individual image.

At step S514, the increment of angulation between each set of images is determined. One tradeoff to be considered is between the ultimate data file size and the smoothness of movement when viewing the interactive sequence. At step S516, the robotic microscope is moved to the first trajectory/position. This can be done manually or through an automated process. At step S518, two 2D images are captured at this trajectory (one from the left eyepiece and one from the right eyepiece). As mentioned above, the images can be captured such that they are limited in view (e.g., limited to the view one would have during actual surgery). Each image can represent a limited portion of the environment and at least two images can contain common image data such that the at least two images overlap.

At step S520, the microscope is moved to the next position. At step S522, the next set of two 2D images is captured. At step S524, steps S520 and S522 are repeated until the entire matrix of image sets have been captured.

At step S526, the stereoscopic multiplexing software (e.g., 3D Stereo Image Factory Plus) is used to combine each set of left/right images into a new horizontally-interlaced image. At step S528, software (e.g., VR Worx) is used to combine all of the horizontally interlaced images into an interactive stereoscopic interface. At step S530, the multimedia authoring software combines the interactive stereoscopic interface with other forms of stereoscopic multimedia (e.g., video and computer animations).

In keeping with aspects of the invention, a user can virtually navigate in the environment. In one embodiment, a viewer (glasses, monitor, etc.) is configured to display a stereoscopic image comprising two two-dimensional images of at least a portion of the environment. It is contemplated that in an alternate embodiment more than two images could be involved. The viewer may include or may be coupled to a computer. A user provides input to an input device, wherein the input device can accept an input that will cause a different stereoscopic image to be viewed. The input device can include a keyboard, joystick, mouse or any other suitable input device. The user then sees what appears to be 3D images of the environment in question. In one embodiment, the images are limited in view (e.g., limited to the view one would have during actual surgery). In another embodiment, the system provides the user with an indication of how the viewing angle changes from one 3D image to the next. It should be noted that the images are a spatially ordered part of the same environment and can be viewed as part of an interactive experience.

Thus, there has been shown a system and method for creating and viewing stereoscopic sequences of an environment. A virtual reality experience is provided to a user that can be used for various applications. These applications include, but are not limited to, surgery.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A method of creating interactive stereoscopic sequences of an environment, the method comprising:
(a) positioning an image capturing device with respect to the environment;
(b) capturing at least two two-dimensional images of at least a portion of the environment using the image capturing device; and
(c) repeating steps (a) and (b) for a plurality of positions of interest;
wherein the images are a spatially ordered part of the same environment and can be viewed as part of an interactive experience.

2. The method of claim 1, wherein the image capturing device is robotically controlled.

3. The method of claim 1, wherein the image capturing device is a digital camera unit.

4. The method of claim 1, wherein each capturing of at least two two-dimensional images is associated with one of a plurality of angles.

5. The method of claim 1, wherein the environment is part of an anatomy and the image capturing device is a digital camera unit that is coupled to a microscope, the digital camera unit including a first digital camera coupled to a first lens of the microscope and a second digital camera coupled to a second lens of the microscope.

6. The method of claim 1, wherein the two-dimensional images of the at least a portion of the environment are captured such that the images are limited in view, wherein each image represents a limited portion of the environment and at least two images can contain common image data such that the at least two images overlap.

7. The method of claim 1, wherein the two-dimensional images of the at least a portion of the environment are captured such that the overall field of view of the environment is limited.

8. The method of claim 1, wherein an animation of the environment is captured by the image capturing device.

9. A method of creating interactive stereoscopic sequences of an environment utilizing a digital camera unit, the method comprising:
(a) positioning the digital camera unit with respect to the environment;
(b) capturing at least two two-dimensional images of at least a portion of the environment; and
(c) repeating steps (a) and (b) for a plurality of positions of interest;
wherein the environment is part of an anatomy and the digital camera unit is coupled to a microscope, the digital camera unit including a first digital camera coupled to a first lens of the microscope and a second digital camera coupled to a second lens of the microscope; and
wherein the two-dimensional images of the at least a portion of the environment are captured such that the images are limited in view, wherein each image represents a limited portion of the environment and at least two images can contain common image data such that the at least two images overlap, and the two-dimensional images of the at least a portion of the environment are captured such that the overall field of view of the environment is limited.

10. The method of claim 9, wherein an animation of the environment is captured by the digital camera unit by capturing the two-dimensional images.

11. A system for creating interactive stereoscopic sequences of an environment utilizing a digital camera unit, the system comprising:
a digital camera unit positionable with respect to the environment and configured to capture at least two two-dimensional images of at least a portion of the environment at a plurality of digital camera positions of interest;
wherein the two-dimensional images of the at least a portion of the environment are captured such that the images are limited in view, wherein each image represents a limited portion of the environment and at least two images can contain common image data such that the at least two images overlap, and the two-dimensional images of the at least a portion of the environment are captured such that the overall field of view of the environment is limited; and
wherein the environment is part of an anatomy and the digital camera unit is coupled to a microscope, the digital camera unit including a first digital camera coupled to a first lens of the microscope and a second digital camera coupled to a second lens of the microscope.

12. A method of virtually navigating in an environment, the method comprising:
(a) viewing a first stereoscopic image comprising at least two two-dimensional images of at least a portion of the environment;
(b) providing input to a system to select a different stereoscopic image other than the first stereoscopic image; and
(c) repeating steps (a) and (b) such that a plurality of stereoscopic images are viewed;
wherein the images are a spatially ordered part of the same environment and can be viewed as part of an interactive experience.

13. The method of claim 12, wherein one of a plurality of angles is selected, each angle being associated with a set of two two-dimensional images.

14. The method of claim 13, further comprising providing an indication of how the angle changes from one image to the next.

15. The method of claim 12, wherein the environment is part of an anatomy and the stereoscopic images are taken with the aid of a microscope.

16. The method of claim 12, wherein the two-dimensional images of the at least a portion of the environment are captured such that the images are limited in view, wherein each image represents a limited portion of the environment and at least two images can contain common image data such that the at least two images overlap, and the two-dimensional images of the at least a portion of the environment are images captured such that the overall field of view of the environment is limited.

17. The method of claim 12, wherein an animation of the environment is captured by the digital camera.

18. A method of virtually navigating a portion of an anatomy, the method comprising:
(a) viewing a first stereoscopic image comprising at least two two-dimensional images of at least a portion of the environment;
(b) providing input to a system to select a stereoscopic image other than the first stereoscopic image; and
(c) repeating steps (a) and (b) such that a plurality of stereoscopic images are viewed;
wherein the stereoscopic images are taken with the aid of a microscope; and
wherein the two-dimensional images of the anatomy are images captured such that the images are limited in view, wherein each image represents a limited portion of the anatomy and at least two images can contain common image data such that the at least two images overlap, and the two-dimensional images of the at least a portion of the anatomy are images captured such that the overall field of view of the anatomy is limited.

19. The method of claim 18, wherein an animation of the environment is captured by the digital camera.

20. A system for virtually navigating in an environment, the system comprising:
a viewer configured to display a first stereoscopic image that is comprised of at least two two-dimensional images of at least a portion of the environment; and
an input device, wherein the input device can accept an input that will cause a stereoscopic image other than the first stereoscopic image to be selected;
wherein the environment is part of an anatomy and the stereoscopic images are taken with the aid of a microscope; and
wherein the two-dimensional images of the at least a portion of the environment are captured such that the images are limited in view, wherein each image represents a limited portion of the environment and at least two images can contain common image data such that the at least two images overlap, and the two-dimensional images of the at least a portion of the environment are images captured such that the overall field of view of the environment is limited.

21. A system for virtually navigating in an environment, the system comprising:
viewing means for displaying a first stereoscopic image that is comprised of at least two two-dimensional images of at least a portion of the environment; and
input means for accepting input, wherein the input means can accept an input that will cause a stereoscopic image other than the first stereoscopic image to be selected;
wherein the environment is part of an anatomy and the stereoscopic images are taken with the aid of a microscope; and
wherein the two-dimensional images of the at least a portion of the environment are captured such that the images are limited in view, wherein each image represents a limited portion of the environment and at least two images can contain common image data such that the at least two images overlap, and the two-dimensional images of the at least a portion of the environment are images captured such that the overall field of view of the environment is limited.
